(19) United States
(12) Patent Application Publication
(10) Pub. No.: US 2024/0286403 A1
(43) Pub. Date: Aug. 29, 2024

(54) PRINTING APPARATUS, CONTROL METHOD THEREFOR, AND NON-TRANSITORY COMPUTER-READABLE STORAGE MEDIUM

(71) Applicant: BROTHER KOGYO KABUSHIKI KAISHA, Nagoya (JP)

(72) Inventors: Shota MORIKAWA, Nagoya (JP); Hitomi MIWA, Nagoya (JP)

(21) Appl. No.: 18/590,362

(22) Filed: Feb. 28, 2024

(30) Foreign Application Priority Data
Feb. 28, 2023 (JP) 2023-029877

(51) Int. Cl. B41J 2/045; B41J 2/21; B41M 3/00

(52) U.S. Cl. CPC B41J 2/04551; B41J 2/04586; B41J 2/2103; B41M 3/008

(57) ABSTRACT

A printing apparatus includes: a base head configured to eject a base ink; an image head configured to eject an image ink including a special color ink; and a control device. The control device is configured to execute printing operation in one of printing modes including a first printing mode and a second printing mode, and, when the printing operation is executed the second printing mode, the control device reduces an ejection amount of the base ink, an ejection amount of the image ink, or the ejection amount of the base ink and the ejection amount of the image ink compared to those in the first printing mode.

### REFERENCE TO RELATED APPLICATIONS

This application claims priority from Japanese Patent Application No. 2023-029877 filed on Feb. 28, 2023. The entire content of the priority application is incorporated herein by reference.

### BACKGROUND ART

A related-art printer includes a head unit that ejects an ink to a medium. The head unit may include color heads that eject color inks such as a cyan ink, a magenta ink, a yellow ink, and a black ink, and a special head that ejects a special color ink such as a white ink. An image is printed on the medium by the ejected inks.

### SUMMARY

The printer in the related art ejects the white ink from the special head to form a white image, which is an image with the white ink, on the medium. Accordingly, the printer ejects the color inks from the color heads to form a color image, which is an image with the color inks, on the white image. In this case, if the color inks are ejected while the white image is not dried, there is a problem that the color inks bleed on the white image and image quality is deteriorated.

An object of the present disclosure is to provide a printing apparatus, a control method therefor, and a non-transitory computer-readable storage medium storing a program for a control device of a printing apparatus, which are capable of reducing bleeding of an image ink on a base layer.

A printing apparatus according to the present disclosure includes: a base head configured to eject a base ink; an image head configured to eject an image ink including a special color ink; and a control device. The control device is configured to execute printing operation in one of printing modes including a first printing mode and a second printing mode, the printing operation in which the base ink is ejected from the base head to form a base layer on a medium to be printed, and the image ink is ejected from the image head to form an image layer on the base layer. When the printing operation is executed in the second printing mode, the control device reduces an ejection amount of the base ink, an ejection amount of the image ink, or the ejection amount of the base ink and the ejection amount of the image ink compared to those in the first printing mode.

In a control method for a printing apparatus according to the present disclosure, the printing apparatus includes: a base head configured to eject a base ink, and an image head configured to eject an image ink including a special color ink. The control method includes: executing a printing operation in one of printing modes including a first printing mode and a second printing mode, the printing operation in which the base ink is ejected from the base head to form a base layer on a medium to be printed, and the image ink is ejected from the image head to form an image layer on the base layer, and reducing, in the second printing mode, an ejection amount of the base ink, an ejection amount of the image ink, or the ejection amount of the base ink and the ejection amount of the image ink compared to an ejection amount of a corresponding ink in the first printing mode.

In a non-transitory computer-readable storage medium storing a program for a control device of a printing apparatus, the printing apparatus includes a base head configured to eject a base ink, and an image head configured to eject an image ink including a special color ink. The program causes the control device to execute a process including: executing a printing operation in one of printing modes including a first printing mode and a second printing mode, the printing operation in which the base ink is ejected from the base head to form a base layer on a medium to be printed, and the image ink is ejected from the image head to form an image layer on the base layer, and reducing, in the second printing mode, an ejection amount of the base ink, an ejection amount of the image ink, or the ejection amount of the base ink and the ejection amount of the image ink compared to an ejection amount of a corresponding ink in the first printing mode.

According to the present disclosure, in the case where the printing operation is executed in the second printing mode, an ejection amount of the base ink, an ejection amount of the image ink, or the ejection amount of the base ink and the ejection amount of the image ink are smaller than those in the first printing mode. Accordingly, bleeding of the image ink on the base ink can be reduced.

### BRIEF DESCRIPTION OF DRAWINGS

FIG. 1 is a schematic diagram of a printing apparatus according to an embodiment and modifications as viewed from above.

FIG. 2 is a schematic diagram of heads provided in the printing apparatus as viewed from below.

FIG. 3 is a block diagram showing a functional configuration of the printing apparatus.

FIG. 4A is a schematic diagram showing a base layer and an image layer in a case where an ejection amount of a base ink in a second printing mode is smaller than that in a first printing mode. FIG. 4B is a schematic diagram showing the base layer and the image layer in a case where an ejection amount of an image ink in the second printing mode is smaller than that in the first printing mode. FIG. 4C is a schematic diagram showing the base layer and the image layer in a case where the ejection amounts of the image ink and the base ink in the second printing mode are smaller than those in the first printing mode.

FIG. 5 is a flowchart showing an example of a control method for the printing apparatus.

FIG. 6 is a table showing a first base LUT.

FIG. 7 is a graph showing a correspondence relationship between W in the second printing mode and a hue angle of a pixel in the first base LUT.

FIG. 8 is a graph showing a correspondence relationship between W in a second printing mode and a hue angle of a pixel in the first base LUT according to another embodiment.

FIG. 9 is a table showing a second base LUT.

FIG. 10 is a schematic diagram showing color patches.

FIG. 11 is a table showing a third base LUT.

FIG. 12 is a graph showing a correspondence relationship between W in the second printing mode and a color difference in the third base LUT.

FIG. 13 is a flowchart showing an example of a control method for a printing apparatus according to fourth modification.

### DESCRIPTION

Hereinafter, an embodiment according to the present disclosure will be described in detail with reference to the drawings. Hereinafter, the same or corresponding elements are denoted by the same reference numerals in the drawings.

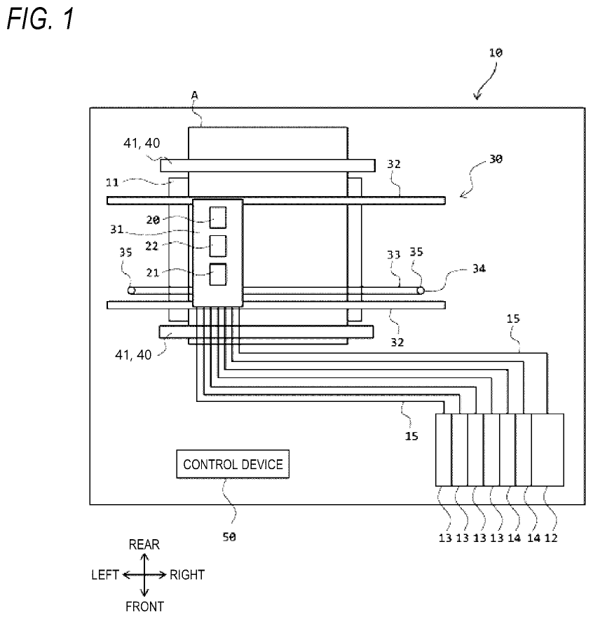

As shown in the example of FIG. 1, a printing apparatus 10 according to the embodiment of the present disclosure is, for example, a serial head type ink jet printer. The printing apparatus 10 includes a base head 20 that ejects a base ink, and image heads 21, 22 that eject image inks including special color inks. The image heads 21, 22 are the first image head 21 that ejects a first image ink and the second image head 22 that ejects a second image ink. Details of the heads 20 to 22 will be described later. The printing apparatus 10 is not limited to the serial head type printer, and may be a line head type printer.

The printing apparatus 10 prints an image on a medium to be printed A by alternately repeating pass processing of ejecting inks while moving the heads 20 to 22 based on print data and conveyance processing of conveying the medium to be printed A. Hereinafter, a moving direction of the heads 20 to 22 is referred to as a left-right direction, and a direction intersecting (for example, orthogonal to) the left-right direction, which is a conveying direction of the medium to be printed A, is referred to as a front-rear direction. A direction intersecting (for example, orthogonal to) both the left-right direction and the front-rear direction is referred to as an up-down direction. However, the directions related to the printing apparatus 10 are not limited thereto. As the medium to be printed A, for example, paper and fabric are used.

The printing apparatus 10 includes a platen 11 disposed to face lower surfaces of the heads 20 to 22. The platen 11 is located below the heads 20 to 22 with a predetermined distance therebetween. A flat upper surface of the platen 11 supports the medium to be printed A from below.

The printing apparatus 10 includes a moving device 30 that reciprocates the heads 20 to 22 in the left-right direction. The moving device 30 includes a carriage 31, two guide rails 32, an endless belt 33, and a moving motor 34. The carriage 31 is a box-shaped casing, and the plurality of heads 20 to 22 are mounted on the carriage 31. The two guide rails 32 extend in the left-right direction on the platen 11, and are disposed apart from each other in the front-rear direction so as to sandwich all the heads 20 to 22 therebetween. The carriage 31 is supported by the two guide rails 32 so as to be capable of reciprocating in the left-right direction. The endless belt 33 is wound around two pulleys 35 provided near both left and right ends of one guide rail 32, is connected to the carriage 31, and is connected to the moving motor 34 via the pulley 35. Accordingly, in the moving device 30, when the moving motor 34 performs rotational driving, the endless belt 33 travels, and the carriage 31 supporting the heads 20 to 22 moves in the left-right direction along the guide rails 32.

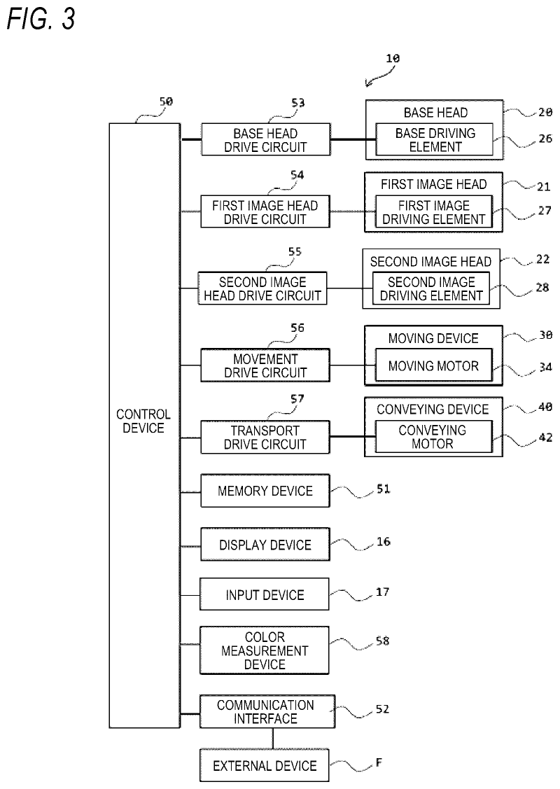

The printing apparatus 10 includes a conveying device 40 that conveys the medium to be printed A in the front-rear direction. The conveying device 40 includes, for example, conveying rollers 41 and a conveying motor 42 (FIG. 3). The conveying roller 41 has a shaft extending in the left-right direction, and the conveying motor 42 is connected to the shaft of the conveying roller 41. When the conveying motor 42 performs rotational driving, the conveying rollers 41 rotate about the shafts and convey the medium to be printed A in the front-rear direction on the platen 11.

The printing apparatus 10 includes a base tank 12 and image tanks 13, 14 that supply inks to the heads 20 to 22. The base tank 12 stores the base ink, is connected to the base head 20 through a tube 15, and supplies the base ink to the base head 20. As the base ink, for example, a white ink is used. Hereinafter, a case where the white ink is used as the base ink will be described, but the base ink is not limited thereto, and may be, for example, a liquid such as a treatment agent containing no color material.

The image tanks 13, 14 include one or more (four in the example of FIG. 1) first image tanks 13 and one or more (two in the example of FIG. 1) second image tanks 14. The first image tank 13 stores the first image ink, is connected to the first image head 21 through the tube 15, and supplies the first image ink to the first image head 21. The second image tank 14 stores the second image ink, is connected to the second image head 22 through the tube 15, and supplies the second image ink to the second image head 22.

The image ink includes special color inks, for example, the first image ink and the second image ink. The first image ink is a predetermined basic color ink. The basic color ink includes, for example, a cyan ink, a magenta ink, a yellow ink, and a black ink. The second image ink is an ink of a different color from the base ink and the first image ink, and includes, for example, a special color ink. In the following description, the basic color ink is described as the first image ink, and the special color ink is described as the second image ink, but the first image ink and the second image ink are not limited thereto. For example, the first image ink may be the special color ink, and the second image ink may be the basic color ink.

The second image ink is an image ink ejected from the second image head 22 closer to the base head 20 than the first image head 21 as described later. Hereinafter, the special color ink is described as the second image ink, but the second image ink is not limited to the special color ink as long as the image ink is ejected from the second image head 22 close to the base head 20, and may be, for example, an ink other than the special color ink. The special color ink is an ink of a color different from the basic color, and for example, an orange ink, a green ink, a fluorescent color ink, a pastel color ink, a pale color ink, or the like is used. Hereinafter, the special color ink, which includes the orange ink and the green ink, is described as the second image ink, but the second image ink is not limited thereto.

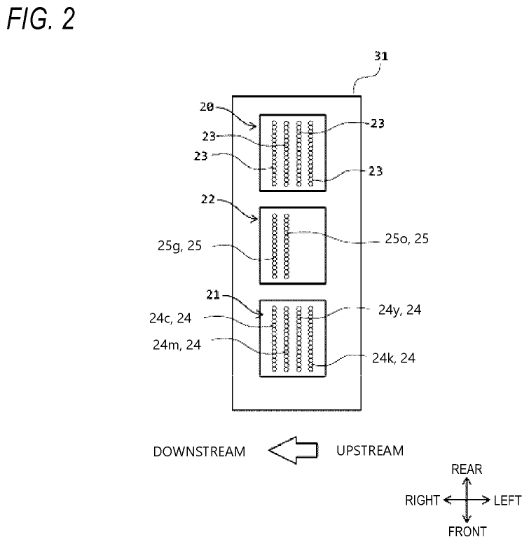

As shown in FIG. 2, for example, the base head 20, the first image head 21, and the second image head 22 are mounted on the carriage 31. The base head 20, the second image head 22, and the first image head 21 are arranged in this order in the front-rear direction from the rear. Therefore, the second image head 22 is located closer to the base head 20 than the first image head 21.

A plurality of base nozzles 23 are opened in the lower surface of the base head 20. The plurality of base nozzles 23 are arranged along the front-rear direction to form a base nozzle row. For example, four base nozzle rows are arranged at intervals in the left-right direction in the base head 20. For example, the white ink is ejected from the base nozzles 23 of each of the four base nozzle rows.

A plurality of second image nozzles 25 are opened in the lower surface of the second image head 22. The plurality of second image nozzles 25 are arranged along the front-rear direction to form a second image nozzle row. For example, two second image nozzle rows are arranged in the second image head 22 at an interval in the left-right direction. For example, of the two second image nozzle rows, the right second image nozzle row is a green nozzle row, and the left second image nozzle row is an orange nozzle row. The green nozzle row has green nozzles 25g that are second image nozzles 25 ejecting the green ink. The orange nozzle row has orange nozzles 25o that are second image nozzles 25 ejecting the orange ink. The second image head 22 may be provided with a second image nozzle row that does not eject the second image ink, in addition to the second image nozzle rows that eject the second image ink. For example, in the example of FIG. 2, two second image nozzle rows that do not eject the second image ink may be arranged on the left of the orange nozzle row.

A plurality of first image nozzles 24 are opened in the lower surface of the first image head 21. The plurality of first image nozzles 24 are arranged along the front-rear direction to form a first image nozzle row. For example, four first image nozzle rows are arranged at intervals in the left-right direction in the first image head 21. For example, the four first image nozzle rows include a cyan nozzle row, a magenta nozzle row, a yellow nozzle row, and a black nozzle row, and these rows are arranged in this order. The cyan nozzle row includes cyan nozzles 24c that are first image nozzles 24 ejecting the cyan ink. The magenta nozzle row includes magenta nozzles 24m that are first image nozzles 24 ejecting the magenta ink. The yellow nozzle row includes yellow nozzles 24y that are first image nozzles 24 ejecting the yellow ink. The black nozzle row includes black nozzles 24k that are first image nozzles 24 ejecting the black ink.

As shown in FIG. 3, the base head 20 is provided with a base driving element 26 for each base nozzle 23. The first image head 21 is provided with a first image driving element 27 for each first image nozzle 24. The second image head 22 is provided with a second image driving element 28 for each second image nozzle 25. The base driving element 26, the first image driving element 27, and the second image driving element 28 are piezoelectric elements, heating elements, electrostatic actuators, or the like, and are driven to apply pressures for ejecting the inks from the corresponding nozzles to the inks in the heads 20 to 22. Thus, the inks are ejected from the nozzles.

The printing apparatus 10 further includes a control device 50, a memory device 51 connected to the control device 50, a communication interface 52, a base head drive circuit 53, a first image head drive circuit 54, a second image head drive circuit 55, a movement drive circuit 56, a conveyance drive circuit 57, a display device 16, and an input device 17. The printing apparatus 10 may be implemented by single apparatus, or may have a configuration in which a plurality of apparatuses are arranged in a distributed manner and cooperate with each other to operate the printing apparatus 10.

The memory device 51 is a memory accessible from the control device 50, and includes, for example, a RAM and a ROM. The memory device 51 stores, for example, image data of an image, print data which is image data converted for printing the image, a program and data for executing various operations such as a printing operation, and the like.

The control device 50 is implemented by, for example, a computer, and includes a processor such as a CPU and a circuit such as an integrated circuit like an ASIC. The control device 50 executes the program stored in the memory device 51 while referring to the data stored in the memory device 51 to control the operation of each part of the printing apparatus 10. The control device 50 may be implemented by a single device, or may have a configuration in which a plurality of devices are arranged in a distributed manner and cooperate with each other to operate the control device 50.

The communication interface 52 is a connection device connected to an external device F by wired communication or wireless communication. The printing apparatus 10 transmits and receives data such as image data of an image to be printed to and from the external device F that is present separately from the printing apparatus 10 via the communication interface 52. Examples of the external device F include another computer, a communication network, a recording medium, a display, and another printing apparatus.

The base head drive circuit 53 is connected to the base driving element 26. The control device 50 generates a control signal for driving the base driving element 26 based on the print data, and the base head drive circuit 53 generates a drive signal for the base driving element 26 based on the control signal. The base driving element 26 is driven based on the drive signal, and applies predetermined ejection energy to the base ink in the base head 20 at a predetermined timing. Accordingly, an ejection timing and an amount (the size of an ink droplet) of the base ink to be ejected from the base nozzle 23 are controlled by the control device 50.

Similarly to the base head drive circuit 53, the first image head drive circuit 54 is connected to the first image driving element 27, and the second image head drive circuit 55 is connected to the second image driving element 28. Accordingly, similarly to the base driving element 26, an ejection timing and an amount of the first image ink to be ejected from the first image nozzles 24 by driving the first image driving element 27 are controlled by the control device 50, and an ejection timing and an amount of the second image ink to be ejected from the second image nozzles 25 by driving the second image driving element 28 are controlled by the control device 50.

The movement drive circuit 56 is connected to the moving motor 34 of the moving device 30. The control device 50 generates a control signal for driving the moving motor 34 based on the print data, and the movement drive circuit 56 generates a drive signal for the moving motor 34 based on the control signal. The moving motor 34 is driven based on the drive signal to move the carriage 31 supporting the heads 20 to 22 in the left-right direction at a variable speed and stop the carriage 31 at any position within a movable range.

The conveyance drive circuit 57 is connected to the conveying motor 42 of the conveying device 40. The control device 50 generates a control signal for driving the conveying motor 42 based on the print data, and the conveyance drive circuit 57 generates a drive signal for the conveying motor 42 based on the control signal. The conveying motor 42 is driven based on the drive signal to intermittently or continuously convey the medium to be printed A on the platen 11 in the front-rear direction and stop the medium to be printed A at a predetermined position on the platen 11.

The display device 16 is a device such as a display that displays information such as information related to the printing operation. The input device 17 is a device that receives input of information from the outside, such as a touch panel, a physical switch, and the communication interface 52. The input device 17 receives an operation by a user and the received operation information is input to the control device 50.

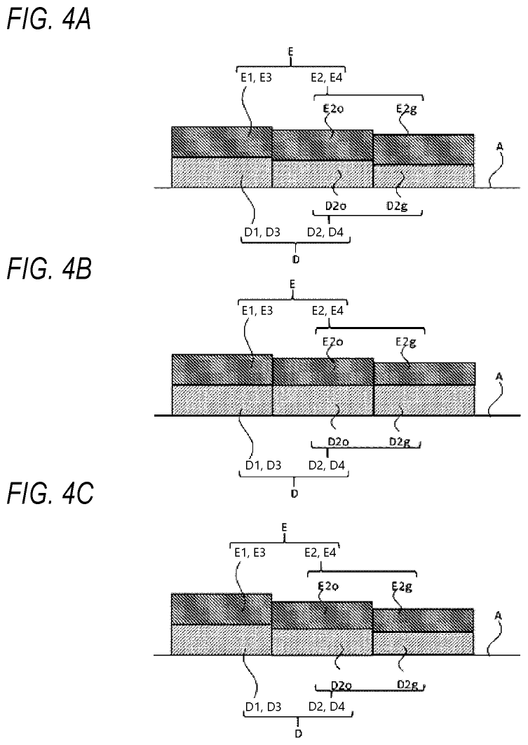

In the printing operation, the control device 50 alternately repeats pass processing of ejecting inks from the heads 20 to 22 while moving the heads 20 to 22 and conveyance processing of conveying the medium to be printed A based on the print data converted from the image data. Accordingly, the image is printed on the medium to be printed A. In this pass processing, as shown in FIG. 4A, the control device 50 makes the base head 20 eject the base ink, and a base layer D is formed on the medium to be printed A by the base ink. Accordingly, the control device 50 makes the image heads 21 and 22 eject the image inks, and an image layer E is formed on the base layer D by the image inks. A printed image is represented by the image layer E.

The image layer E includes a first image region E1 and a second image region E2. The first image region E1 is a region formed by an image ink not including the second image ink, and is formed by the first image ink without being formed by the second image ink. The first image ink forming the first image region E1 may be of one type or a plurality of types. Examples of the first image region E1 include a cyan region formed by the cyan ink and a blue region formed by the cyan ink and the magenta ink.

The second image region E2 is a region formed by an image ink containing the second image ink, and is formed by one or more types of the second image inks, or is formed by one or more types of the second image inks and one or more types of the first image inks. For example, the second image region E2 has a green image region E2g formed by an image ink containing the green ink which is the special color ink of the second image ink, and an orange image region E2o formed by an image ink containing the orange ink which is the special color ink of the second image ink. The green image region E2g and the orange image region E2o may be formed by an ink other than the special color ink in addition to the special color ink.

The base layer D includes a first base region D1 and a second base region D2. Both the first base region D1 and the second base region D2 are formed of the base ink. The first base region D1 is a region corresponding to the first image region E1, the first image region E1 is stacked thereon. The second base region D2 is a region corresponding to the second image region E2, and the second image region E2 is stacked thereon. For example, the second base region D2 has a green base region D2g on which the green image region E2g is stacked, and an orange base region D2o on which the orange image region E2o is stacked.

The second image head 22 is located closer to the base head 20 than the first image head 21. Accordingly, the inks are ejected from the base head 20, the second image head 22, and the first image head 21 in this order. Therefore, time from the ejection of the base ink from the base head 20 to the ejection of the second image ink from the second image head 22 onto the base ink is shorter than time from the ejection of the base ink from the base head 20 to the ejection of the first image ink from the first image head 21 onto the base ink. Accordingly, drying time of the base ink from landing of the base ink to landing of the second image ink on the base ink is shorter than drying time of the base ink from landing of the base ink to landing of the first image ink on the base ink. Thus, the second image ink ejected onto the base layer D of the base ink more easily bleeds than the first image ink ejected onto the base layer D.

A printing mode of the printing operation includes a first printing mode and a second printing mode for reducing bleeding of an image ink as compared with the first printing mode. In a case where the printing operation is executed in the second printing mode, the control device 50 reduces the ejection amount of the base ink forming the base layer D compared to that in the first printing mode. Further, the first image region E1 corresponding to the first base region D1 of the base layer D is not formed by the second image ink, but the second image region E2 corresponding to the second base region D2 is formed by the second image ink. Therefore, in the case where the printing operation is executed in the second printing mode, the control device 50 reduces the ejection amount of the base ink forming the second base region D2 of the base layer D compared to that in the first printing mode.

For example, when the ejection amount of the base ink to the second base region D2 is 100% in the first printing mode, the ejection amount of the base ink to the second base region D2 is less than 100% in the second printing mode. Accordingly, the amount of the base ink forming the second base region D2 in the second printing mode is smaller than that in the first printing mode, and the second base region D2 dries more readily. Therefore, even when the second image ink is ejected onto the second base region D2, the bleeding of the second image ink can be reduced.

As shown in FIG. 4A, regarding the ejection amount of the base ink to the second base region D2 in the second printing mode, for example, the ejection amount of the base ink to the green base region D2g of the second base region D2 may be smaller than the ejection amount of the base ink to the orange base region D2o. That is, in the example of FIG. 2, in the second image head 22, the green nozzles 25g that eject the green ink are disposed on a right side of the orange nozzles 25o that eject the orange ink. When the second image head 22 ejects the ink while moving to the right in the pass processing of the printing operation, the green nozzles 25g are disposed downstream of the orange nozzles 25o in the moving direction of the second image head 22. Therefore, time from the ejection of the base ink to the ejection of the green ink onto the base ink is shorter than time from the ejection of the base ink to the ejection of the orange ink onto the base ink. Accordingly, drying time of the base ink from the landing of the base ink to landing of the green ink on the base ink is shorter than drying time of the base ink from the landing of the base ink to landing of the orange ink on the base ink. Therefore, the green ink ejected onto the second base region D2 of the base ink more easily bleeds than the orange ink ejected onto the second base region D2.

In the case where the printing operation is executed in the second printing mode, the control device 50 may reduce the ejection amount of the base ink to the green base region D2g to which the green ink is ejected of the second base region D2 compared to the ejection amount of the base ink to the orange base region D2o to which the orange ink is ejected. For example, when the ejection amount of the base ink to the second base region D2 is 100% in the first printing mode, the ejection amount of the base ink to the green base region D2g of the second base region D2 is 75% in the second printing mode, and the ejection amount of the base ink to the orange base region D2o of the second base region D2 is 90%. Accordingly, it is possible to reduce bleeding of the special color ink in the second base region D2 while suppressing deterioration in image quality due to a decrease in the base ink in the second base region D2.

In the case where the printing operation is executed in the second printing mode, the control device 50 may make the ejection amount of the base ink forming the first base region D1 equal to that in the first printing mode. In the case where the printing operation is executed in the second printing mode, the control device 50 may reduce the ejection amount of the base ink forming the first base region D1 compared to that in the first printing mode. A difference obtained by subtracting the ejection amount of the base ink to the first base region D1 in the second printing mode from the ejection amount of the base ink to the first base region D1 in the first printing mode is smaller than a difference obtained by subtracting the ejection amount of the base ink to the second base region D2 in the second printing mode from the ejection amount of the base ink to the second base region D2 in the first printing mode. In this way, it is possible to suppress deterioration of the image quality of the printed image due to a decrease in the ejection amount of the base ink by not decreasing the ejection amount of the base ink to the first base region D1 in the second printing mode as compared with the first printing mode or by suppressing the decrease amount. In the case where the printing operation is executed in the second printing mode, the control device 50 may make the ejection amount of the base ink forming the first base region D1 equal to the ejection amount of the base ink forming the second base region D2. In this case, the thickness of the first base region D1 may be equal to the thickness of the second base region D2.

In the case where the printing operation is executed in the second printing mode, the control device 50 may make the ejection amount of the first image ink forming the first image region E1 and the ejection amount of the image ink forming the second image region E2 (the ejection amount of the second image ink, or the ejection amount of the first image ink and the ejection amount of the second image ink) equal to those in the first printing mode. In the case where the printing operation is executed in the second printing mode, the control device 50 may reduce the ejection amount of the first image ink forming the first image region E1 compared to that in the first printing mode. A difference obtained by subtracting the ejection amount of the image ink to the first image region E1 in the second printing mode from the ejection amount of the image ink to the first image region E1 in the first printing mode is smaller than a difference obtained by subtracting the ejection amount of the base ink to the second base region D2 in the second printing mode from the ejection amount of the base ink to the second base region D2 in the first printing mode. When the printing operation is executed in the second printing mode, the control device 50 may reduce the ejection amount of the image ink forming the second image region E2 compared to that in the first printing mode. A difference obtained by subtracting the ejection amount of the base ink to the second image region E2 in the second printing mode from the ejection amount of the base ink to the second image region E2 in the first printing mode is smaller than a difference obtained by subtracting the ejection amount of the base ink to the second base region D2 in the second printing mode from the ejection amount of the base ink to the second base region D2 in the first printing mode. In this way, it is possible to suppress the deterioration of the image quality of the printed image due to the decrease of the ejection amount of the image ink by not decreasing the ejection amounts of the image inks forming the first image region E1 and the second image region E2 in the second printing mode as compared with the first printing mode or by suppressing the decrease amounts.

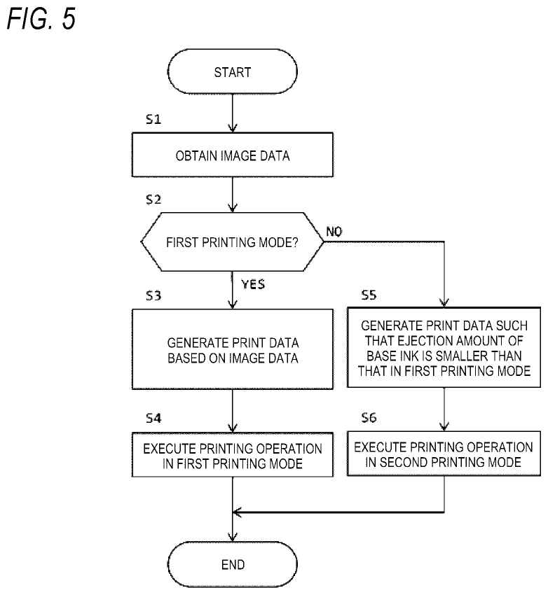

A control method for the printing apparatus 10 is executed by the control device 50 in accordance with an example of a flowchart shown in FIG. 5. First, the control device 50 obtains image data of an image to be printed on the medium to be printed A from the memory device 51 or the communication interface 52 (step S1).

Subsequently, the control device 50 determines whether the printing mode is the first printing mode (step S2). Here, for example, the control device 50 displays the first printing mode and the second printing mode on the display device 16 as options of the printing mode. When the user selects a printing mode using the input device 17, the selected printing mode is input to the control device 50. When the user selects the printing mode using the external device F such as another computer, the selected printing mode may be input from the external device F to the control device 50 through the communication interface 52. In this case, the communication interface 52 functions as the input device 17 through which the user inputs information to the control device 50.

If the printing mode is the first printing mode (step S2: YES), the control device 50 generates print data based on the image data (step S3). Here, for example, the control device 50 executes color conversion processing or the like on the image data defined by RGB using a predetermined first LUT to convert the image data into the print data defined by CMYKogW. The first LUT is, for example, a color conversion lookup table in which RGB corresponds to CMYKogW, and is stored in the memory device 51 in advance. The RGB is represented by, for example, gradation values of 0 to 255 representing 256 gradations of red, green, and blue for each pixel of the image.

CMYKogW corresponds to the color of the ink provided in the printing apparatus 10, and is represented by, for example, a gradation value of 101 gradations of 0 to 100%. CMYK are gradation values of cyan, magenta, yellow, and black, which are basic colors of the first image ink in the first image region E1 and the second image region E2. o is a gradation value of orange which is a special color of the second image ink in the second image region E2, and g is a gradation value of green which is a special color of the second image ink in the second image region E2. W is a gradation value of white which is a color of the base ink in each of the first base region D1 and the second base region D2.

The gradation values of CMYKogW correspond to the ejection amounts of inks to the image layer E and the base layer D per unit area, respectively. For example, the gradation values of CMYK are the amounts of the first image inks (the cyan ink, the magenta ink, the yellow ink, and the black ink) ejected to the first image region E1 and the second image region E2, respectively. Gradation values of “og” are the amounts of the second image inks (the orange ink, the green ink) ejected to the second image region E2, respectively. A gradation value of W is the amount of base ink (the white ink) ejected to the first base region D1 and the second base region D2. The first image region E1 and the second image region E2 are regions of a unit area when the image layer E is divided into a plurality of regions each having a predetermined area, and correspond to pixels constituting the image. The first base region D1 and the second base region D2 are regions of a unit area when the base layer D is divided into a plurality of regions each having a predetermined area.

The control device 50 executes the printing operation in the first printing mode based on the print data (step S4). In this printing operation, an amount of ink corresponding to the gradation value of the print data is ejected in the pass processing. Here, the base ink is ejected onto the medium to be printed A to form the base layer D. Then, the first image ink is ejected onto the first base region D1 of the base layer D to form the first image region E1, and the second image ink, or the second image ink and the first image ink are ejected onto the second base region D2 of the base layer D to form the second image region E2. The ejection amount of the base ink to the first base region D1 is equal to the ejection amount of the base ink to the second base region D2. Accordingly, it is possible to suppress deterioration in image quality due to a difference in the ejection amount of the base ink to the base layer D.

In step S2, if the printing mode is the second printing mode (step S2: NO), the control device 50 generates print data based on the image data such that the ejection amount of the base ink is smaller than that in the first printing mode (step S5). Here, for example, the control device 50 executes color conversion processing or the like on image data defined by RGB using a predetermined second LUT to convert the image data into print data defined by CMYKogW. The second LUT is a color conversion lookup table in which RGB corresponds to CMYKogW, and is stored in the memory device 51 in advance.

The second LUT is similar to the first LUT except for W. Therefore, CMYKog for RGB in the second LUT is the same as that in the first LUT. Thus, the ejection amounts of the image inks to the first image region E1 and the second image region E2 in the printing operation of step S6 to be described later correspond to CMYKog of the first LUT and the second LUT, and thus are equal in the second printing mode and in the first printing mode.

In the first LUT, W in the second printing mode is 100% of RGB of the pixels corresponding to the first image region E1 and the second image region E2. On the other hand, in the second LUT, W in the second printing mode is 100% of RGB of the pixel corresponding to the first image region E1, but is smaller than 100% of RGB of the pixel corresponding to the second image region E2. For example, W in the second printing mode is 75% of RGB of the pixel corresponding to the green image region E2g in the second image region E2. W in the second printing mode is 90% of RGB of the pixel corresponding to the orange image region E2o in the second image region E2.

The control device 50 executes the printing operation in the second printing mode based on the print data (step S6). In this printing operation, in the pass processing, an amount of ink based on the print data is ejected, and the base layer D and the image layer E are formed in this order on the medium to be printed A. For example, in the base layer D, the first base region D1 is formed by the base ink with the ejection amount of 100%, the green base region D2g of the second base region D2 is formed by the base ink with the ejection amount of 75%, and the orange base region D2o of the second base region D2 is formed by the base ink with the ejection amount of 90%.

In this way, the second base region D2 of the base layer D is formed of the base ink having the ejection amount of 100% in the first printing mode, and is formed of the base ink having the ejection amount of 90% or 75% in the second printing mode. By making the ejection amount of the base ink to the base layer D in the second printing mode smaller than that in the first printing mode, the base layer D dries more readily in the second printing mode than in the first printing mode, and thus bleeding of the image ink ejected onto the base layer D in the printing operation in the second printing mode can be reduced.

Further, since the second image head 22 is closer to the base head 20 than the first image head 21, the second image ink ejected from the second image head 22 to the second base region D2 easily bleeds. Meanwhile, by making the ejection amount of the base ink to the second base region D2 in the second printing mode smaller than that in the first printing mode, the second base region D2 dries more readily in the second printing mode than in the first printing mode, and thus bleeding of the second image ink ejected onto the second base region D2 in the printing operation in the second printing mode can be reduced. Further, it is possible to suppress deterioration in the image quality of the printed image due to a decrease in the base ink in the base layer D in the printing operation in the second printing mode by making the ejection amount of the base ink to the first base region D1 in the second printing mode equal to that in the first printing mode.

Further, the green nozzles 25g are disposed downstream of the orange nozzles 25o in the moving direction of the second image head 22 that moves while ejecting the ink in the printing operation. Therefore, the drying time of the base ink from the landing of the base ink to the landing of the green ink on the base ink is shorter than the drying time of the base ink from the landing of the base ink to the landing of the orange ink on the base ink, and the green ink more easily bleeds on the second base region D2 than the orange ink. In the other hand, in the printing operation in the second printing mode, the control device 50 decreases the ejection amount of the base ink to the green base region D2g of the second base region D2 with respect to the orange base region D2o. Therefore, it is possible to reduce bleeding of the green ink on the green base region D2g while suppressing deterioration in image quality due to a decrease in the base ink in the orange base region D2o.

In the above description, when the printing operation is executed in the second printing mode, the control device 50 reduces the ejection amount of the base ink compared to that in the first printing mode as shown in FIG. 4A. However, reducing the ejection amount of ink in the second printing mode compared to than that in the first printing mode is not limited to the base ink. For example, as shown in FIG. 4B, when the printing operation is executed in the second printing mode, the control device 50 may reduce the ejection amount of the image ink compared to than that in the first printing mode. As shown in FIG. 4C, when the printing operation is executed in the second printing mode, the control device 50 may reduce the ejection amount of the base ink and the ejection amount of the image ink compared to than those in the first printing mode.

In the example of FIG. 4B, in a case where the second image ink is the green ink, when the ejection amount of the green ink to the second image region E2 in the first printing mode is 100%, the control device 50 sets the ejection amount of the green ink to the second image region E2 in the second printing mode to 75%. When the second image ink is an orange ink, the control device 50 sets the ejection amount of the orange ink to the second image region E2 in the second printing mode to 90% when the ejection amount of the orange ink to the second image region E2 in the first printing mode is set to 100%. In this way, when the printing operation is executed in the second printing mode, the control device 50 reduces the ejection amount of the second image ink compared to that in the first printing mode. Accordingly, since the amount of the second image ink ejected to the second base region D2 decreases, the second image ink is unlikely to spread, and bleeding of the second image ink on the second base region D2 can be reduced.

Here, in a case where the second image region E2 is formed by the first image ink and the second image ink, in the second printing mode, in addition to the ejection amount of the second image ink to the second image region E2, the ejection amount of the first image ink may be smaller than that in the first printing mode. For example, in a case where the second image ink is the green ink, in the second printing mode, the control device 50 sets both the ejection amount of the second ink to the second image region E2 and the ejection amount of the first image ink to the same second image region E2 to 75%. In this way, the ejection amount of the image ink to the second image region E2 in the second printing mode is smaller than that in the first printing mode. Accordingly, it is possible to reduce bleeding of the special color ink of the image ink on the second base region D2 while suppressing a change in hue due to a decrease in the image ink in the second image region E2.

On the other hand, in the example of FIG. 4C, when where the printing operation is executed in the second printing mode, the control device 50 reduces the ejection amount of the base ink to the second base region D2 and the ejection amount of the image ink to the second image region E2 compared to those in the first printing mode. For example, in the case where the second image ink is a green ink, in the second printing mode, the control device 50 sets both the ejection amount of the image ink to the second image region E2 (the ejection amount of the second image ink, or the ejection amounts of the first image ink and the second image ink) and the base ink to the second base region D2 corresponding to the second image region E2 to 75%. Accordingly, since the image ink and the base ink dry more readily, it is possible to further reduce bleeding of the image ink in the second base region D2.

In the example of FIG. 4B, in the case where the printing operation is executed in the second printing mode, the control device 50 controls the ejection amount of the base ink to the first base region D1, the ejection amount of the first image ink to the first image region E1, and the ejection amount of the base ink to the second base region D2 equal to those in the first printing mode. In the case where the printing operation is executed in the second printing mode, the control device 50 may make at least one of the ejection amount of the base ink to the first base region D1, the ejection amount of the first image ink to the first image region E1, and the ejection amount of the base ink to the second base region D2 smaller than that in the first printing mode. The difference between the first printing mode and the second printing mode in the ejection amount to be reduced is smaller than the difference between the first printing mode and the second printing mode in the ejection amount of the image ink to the second image region E2. In this way, it is possible to suppress deterioration of the image quality of the printed image due to a decrease of the ink by not decreasing the ejection amount of the ink in the second printing mode as compared with the first printing mode or by suppressing the decrease amount.

In the example of FIG. 4C, when the printing operation is executed in the second printing mode, the control device 50 controls the ejection amount of the base ink to the first base region D1 and the ejection amount of the first image ink to the first image region E 1 equal to those in the first printing mode. When the printing operation is executed in the second printing mode, the control device 50 may reduce at least one of the ejection amount of the base ink to the first base region D1 and the ejection amount of the first image ink to the first image region E1 compared to a corresponding ejection amount in the first printing mode. The difference between the first printing mode and the second printing mode in the ejection amount to be reduced is smaller than a difference between the first printing mode and the second printing mode in the ejection amount of the base ink to the second base region D2 and a difference between the first printing mode and the second printing mode in the ejection amount of the image ink to the second image region E2. In this way, it is possible to suppress deterioration of the image quality of the printed image due to a decrease of the ink by not decreasing the ejection amount of the ink in the second printing mode as compared with the first printing mode or by suppressing the decrease amount. In FIG. 4C, in the case where the printing operation is executed in the second printing mode, the control device 50 may make the ejection amount of the base ink forming the first base region D1 equal to the ejection amount of the base ink forming the second base region D2. In this case, the thickness of the first base region D1 may be equal to the thickness of the second base region D2.

In the above configuration, the basic color ink including the cyan ink, the magenta ink, the yellow ink, and the black ink is used as the first image ink, and the special color ink different from the basic color ink is used as the second image ink. In this case, the first image head 21 corresponds to a basic color head that ejects the basic color ink, and the second image head 22 corresponds to a special color head that ejects the special color ink.

In this case, as shown in FIGS. 4A to 4C, the first image region E1 of the image layer E corresponds to a third image region E3 formed by the basic color ink without being formed by the special color ink, and the second image region E2 of the image layer E corresponds to a fourth image region E4 formed by the special color ink. The first base region D1 of the base layer D corresponds to a third base region D3 corresponding to the third image region E3, and the second base region D2 of the base layer D corresponds to a fourth base region D4 corresponding to the fourth image region E4.

In the case where the printing operation is executed in the second printing mode, the control device 50 controls the ejection amount of the base ink forming the fourth base region D4, the ejection amount of the special color ink forming the fourth image region E4, or the ejection amount of the base ink forming the fourth base region D4 and the ejection amount of the special color ink forming the fourth image region E4 smaller than those in the first printing mode. Accordingly, similarly to the above, bleeding of the special color ink on the base ink can be reduced. That is, the inks are ejected from the base head 20, the special color head, and the basic color head in this order. Therefore, time from the ejection of the base ink from the base head 20 to the ejection of the special color ink from the special color head to the base ink is shorter than time from the ejection of the base ink from the base head 20 to the ejection of the basic color ink from the basic color head to the base ink. Accordingly, drying time of the base ink from the landing of the base ink to the landing of the special color ink on the base ink is shorter than drying time of the base ink from the landing of the base ink to the landing of the basic color ink on the base ink. Therefore, the special color ink more easily bleeds on the base ink than the basic color ink. Even in such a case, since the base ink dries readily due to the decrease in the ejection amount of the base ink forming the fourth base region D4, and the special color ink is unlikely to spread due to the decrease in the ejection amount of the special color ink forming the fourth image region E4, the bleeding of the special color ink on the base ink can be reduced.

Here, when the fourth image region E4 is formed of the special color ink and the basic color ink, in addition to the ejection amount of the special color ink forming the fourth image region E4, the ejection amount of the basic color ink may be smaller than that in the first printing mode. Accordingly, similarly to the above, it is possible to suppress a change in hue in the fourth image region E4 while reducing bleeding of the special color ink on the fourth base region D4.

Further, in the case where the printing operation is executed in the second printing mode, the control device 50 may make the ejection amount of the base ink forming the third base region D3 and the ejection amount of the basic color ink forming the third image region E3 equal to those in the first printing mode. In the case where the printing operation is executed in the second printing mode, the control device 50 may make the image ink (the ejection amount of the special color ink, or the ejection amount of the special color ink and the ejection amount of the basic color ink) forming the fourth image region E4 equal to that in the first printing mode in a case where the ejection amount of the base ink forming the fourth base region D4 is smaller than that in the first printing mode. In the case where the printing operation is executed in the second printing mode, the control device 50 may make the ejection amount of the base ink forming the fourth base region D4 equal to that in the first printing mode in a case where the ejection amount of the special color ink forming the fourth image region E4 is smaller than that in the first printing mode.

In the case where the printing operation is executed in the second printing mode, the control device 50 may make at least one of the ejection amount of the base ink forming the third base region D3 and the ejection amount of the basic color ink forming the third image region E3 smaller than that in the first printing mode. In the example of FIG. 4A, the difference between the first printing mode and the second printing mode in the ejection amount to be reduced is smaller than the difference between the first printing mode and the second printing mode in the ejection amount of the base ink to the fourth base region D4. In the example of FIG. 4B, the difference between the first printing mode and the second printing mode in the ejection amount to be reduced is smaller than the difference between the first printing mode and the second printing mode in the ejection amount of the image ink to the fourth image region E4. Further, in the example of FIG. 4C, the difference between the first printing mode and the second printing mode in the ejection amount to be reduced is smaller than the difference between the first printing mode and the second printing mode in the ejection amount of the base ink to the fourth base region D4 and the difference between the first printing mode and the second printing mode in the ejection amount of the image ink to the fourth image region E4. In this way, it is possible to suppress the decrease in the printed image due to the decrease in the ejection amount of the ink by not decreasing the ejection amount of the ink in the second printing mode as compared with the first printing mode or by suppressing the decrease amount. In FIGS. 4A and 4C, in the case where the printing operation is executed in the second printing mode, the control device 50 may make the ejection amount of the base ink forming the third base region D3 equal to the ejection amount of the base ink forming the fourth base region D4. In this case, the thickness of the third base region D3 may be equal to the thickness of the fourth base region D4.

In the printing apparatus 10 according to a first modification directed to the above embodiment, in a case where a printing operation is executed in a second printing mode, the control device 50 makes the base head 20 eject a base ink in an amount corresponding to a hue of an image which is a target of the printing operation.

Specifically, a predetermined LUT is used when the control device 50 generates print data based on the image data in steps S3 and S5 of FIG. 5. The LUT includes an image LUT and a first base LUT, and is stored in the memory device 51 in advance. The image LUT is, for example, a color conversion lookup table in which RGB corresponds to CMYKog, and is similar to the portions other than W in the first LUT and the second LUT.

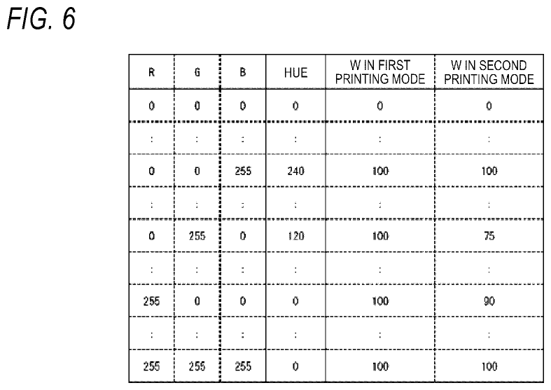

The first base LUT is, for example, a color conversion lookup table in which RGB, a hue, W in the first printing mode, and W in the second printing mode are associated with one another as shown in an example of the table of FIG. 6. Win the first printing mode is a gradation value of white in the first printing mode, and corresponds to the ejection amount of the base ink in the case where the printing operation is executed in the first printing mode. W in the second printing mode is the gradation value of white in the second printing mode, and corresponds to the ejection amount of the base ink in the case where the printing operation is executed in the second printing mode.

The hue is a hue of a pixel constituting the image which is a target of the printing operation, and is calculated as follows, for example, from RGB of the pixel. Here, R, G, and B are obtained from the image data. The maximum value among R, G, and B is MAX, and the minimum value is MIN. In this case, a hue H of the image having the maximum R among R, G, and B is calculated by H=60×{(G−B)+(MAX−MIN)}. A hue H of the image having the maximum G among R, G, and B is calculated by H=60×{(G−B)+(MAX−MIN)}+120. A hue H of the image having the maximum B among R, G, and B is calculated by H=60×{(G−B)+(MAX−MIN)}+240.

In the first base LUT, W corresponding to (R, G, B) which is (0, 0, 0) is 0% regardless of the printing mode. Further, W other than the above W is 100% regardless of the hue of the image in the first printing mode, whereas W changes according to the hue of the image in the second printing mode.

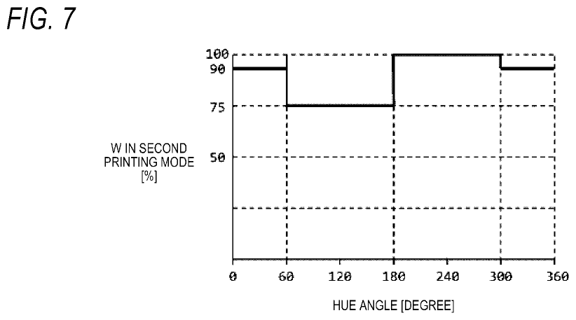

For example, W in the second printing mode corresponds to a hue angle ( degree) of the pixel in FIG. 7. W in the second printing mode is 100% for the first base region D1 corresponding to pixels having hue angles of 60 degrees, 180 degrees or more and less than 300 degrees. That is, since the color of the pixels having the hue angles of 60 degrees, 180 degrees or more and less than 300 degrees does not include the special color, the image region corresponding to this pixel is the first image region E1 and is formed by the first image ink. In the first base region D1 in which the first image region E1 is stacked, the ejection amount of the base ink in the printing operation in the second printing mode is 100%.

Further, W in the second printing mode is 90% for the second base region D2 corresponding to the pixels having a hue angle of less than 60 degrees or greater than 300 degrees. That is, since the color of the pixels having the hue angle of less than 60 degrees or greater than 300 degrees includes orange, the image region corresponding to this pixel is the orange image region E2o of the second image region E2 and is formed by the image ink including the orange ink. In the orange base region D2o of the second base region D2 in which the orange image region E2o is stacked, the ejection amount of the base ink in the printing operation in the second printing mode is 90%.

Further, W in the second printing mode is 75% for the second base region D2 corresponding to a pixel having a hue angle greater than 60 degrees and smaller than 180 degrees. That is, since the color of the pixel having the hue angle greater than 60 degrees and smaller than 180 degrees includes green, the image region corresponding to this pixel is the green image region E2g of the second image region E2 and is formed by the image ink including the green ink. In the green base region D2g of the second base region D2 on which the green image region E2g is stacked, the ejection amount of the base ink in the printing operation in the second printing mode is 75%.

In this way, in the printing operation in the second printing mode, the control device 50 makes the base head 20 eject the base ink in an amount corresponding to the hue of the pixel of the image. For example, in a case where the ejection amounts of the base inks to the first base region D1 and the second base region D2 in the printing operation in the first printing mode are 100%, in the printing operation in the second printing mode, the ejection amount of the base ink to the first base region D1 corresponding to the first image region E1 of the hue not including the special color is 100%, and the ejection amount of the base ink to the second base region D2 corresponding to the second image region E2 of the hue including the special color is 90% or 75%. In this case, the ejection amount of the base ink to the second base region D2 in the second printing mode is smaller than that in the first printing mode, and the bleeding of the image ink on the second base region D2 can be reduced. Here, by decrease the ejection amount of the base ink to the green base region D2g with respect to the orange base region D2o in the second base region D2, it is possible to reduce the bleeding of the image ink in the second base region D2 while suppressing the deterioration in the image quality due to the decrease in the base ink in the second base region D2.

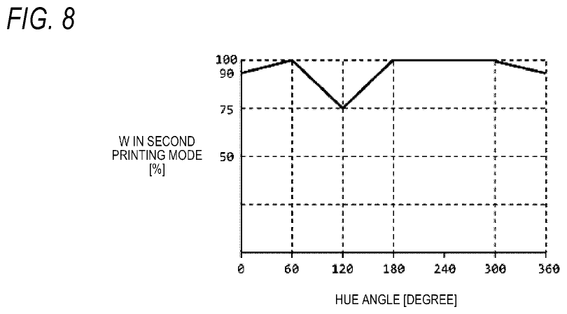

Further, W in the second printing mode may be obtained based on, for example, a graph corresponding to the hue angle of the image shown in the example of FIG. 8. That is, in the graph of FIG. 7, W in the second printing mode changes stepwise with respect to the hue angle. In contrast, in the graph of FIG. 8, W in the second printing mode continuously changes with respect to the hue angle.

For example, in the graph of FIG. 7, W is 100% when the hue angle is 60 degrees or 180 degrees, and W is 75% when the hue angle is greater than 60 degrees and smaller than 180 degrees. In contrast, in the graph of FIG. 8, W is 100% when the hue angle is 60 degrees or 180 degrees, and W is 75% when the hue angle is 120 degrees between 60 degrees and 180 degrees. As the hue angle approaches 120 degrees which is at the center from 60 degrees and 180 degrees, W continuously decreases to 75%.

In this way, since W in the second printing mode continuously changes according to the hue angle of the pixel, the ejection amount of the base ink to the base region D2 corresponding to W also continuously changes. Accordingly, it is possible to suppress deterioration in image quality due to a change in the ejection amount of the base ink.

In the above description, in the case where the printing operation is executed in the second printing mode, the control device 50 makes the base head 20 eject the base ink in an amount corresponding to the hue of the image. In contrast, in the case where the printing operation is executed in the second printing mode, the control device 50 may make the image heads 21, 22 eject the image inks in an amount corresponding to the hue of the image. Further, in the case where the printing operation is executed in the second printing mode, the control device 50 may make the base head 20 eject the base ink in an amount corresponding to the hue of the image, and may make the image heads 21, 22 eject the image inks in an amount corresponding to the hue of the image.

In this case, for example, when the ejection amounts of the image inks to the first image region E1 and the second image region E2 in the printing operation in the first printing mode are 100%, in the printing operation in the second printing mode, the ejection amount of the image ink to the first image region E1 corresponding to the pixels of the hue not including the special color is 100%, and the ejection amount of the image ink to the second image region E2 corresponding to the pixels of the hues including the special color is less than 100%. In the second image region E2, the ejection amount of the image ink to the orange image region E2o is 90%, and the ejection amount of the image ink to the green image region E2g is 75%. In this way, by changing the ejection amounts of the image ink, or the image ink and the base ink in accordance with the hue in the printing operation in the second printing mode, it is possible to reduce bleeding of the image ink in the base layer D while suppressing deterioration in image quality due to a decrease in the ink.

In the printing apparatus 10 according to a second modification directed to the above embodiment, the control device 50 identifies the amount of the special color ink included in the image ink forming the image layer E. In the case where the printing operation is executed in the second printing mode, the control device 50 makes the base head 20 eject the base ink in an amount corresponding to the amount of the special color ink in the image layer E.

Specifically, a predetermined LUT is used when print data is generated based on image data in steps S3 and S5 of FIG. 5. The LUT includes an image LUT and a second base LUT, and is stored in the memory device 51 in advance. The image LUT is, for example, a color conversion lookup table in which RGB corresponds to CMYKog, and is similar to the portions other than W in the first LUT and the second LUT.

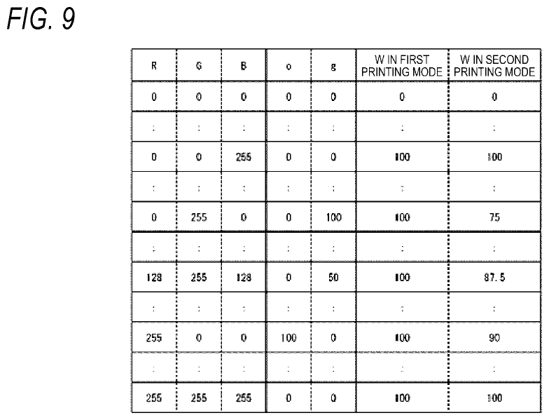

The second base LUT is, for example, a color conversion lookup table in which RGB, o, g, W in the first printing mode, and W in the second printing mode are associated with one another as shown in an example of the table of FIG. 9. Win the first printing mode is the gradation value of white in the first printing mode, and corresponds to the ejection amount of the base ink in the case where the printing operation is executed in the first printing mode. W in the first printing mode is the gradation value of white in the first printing mode, and corresponds to the ejection amount of the base ink in the case where the printing operation is executed in the first printing mode.

In the second base LUT, o is a gradation value of orange of the pixels in the image, and g is a gradation value of green of the pixels in the image. Win each printing mode is 0% for each pixel of which (RGB) is (0, 0, 0). In contrast, for the other pixels, W in the first printing mode is 100% regardless of o and g. In contrast, Win the second printing mode is represented by W=100−(0.1×o+0.25×g).

In this way, the larger the gradation value o of orange and the gradation value g of green in a pixel, the smaller W in the second printing mode for the base region corresponding to the pixel. Accordingly, as at least one of special color inks of the orange ink and the green ink in the second image region E2 corresponding to the pixel increases, the ejection amount of the base ink to the second base region D2 corresponding to the second image region E2 decreases. Accordingly, since the second base region D2 dries more readily, bleeding of the image ink on the second base region D2 can be reduced.

Further, as the gradation value g of green becomes larger than the gradation value o of orange, W in the second printing mode becomes smaller. Accordingly, as the amount of the green ink becomes larger than the amount of the orange ink in the second image region E2, the ejection amount of the base ink to the second base region D2 decreases. Therefore, bleeding of the green ink, which more easily bleeds than the orange ink, on the second base region D2 can be reduced.

In the above description, when the printing operation is executed in the second printing mode, the control device 50 makes the base head 20 eject the base ink in the amount corresponding to the amount of the special color ink contained in the image layer E. On the other hand, in the case where the printing operation is executed in the second printing mode, the control device 50 may make the image head eject the image ink in an amount corresponding to the amount of the special color ink in the image layer E. In the case where the printing operation is executed in the second printing mode, the control device 50 may make the base head 20 eject the base ink in an amount corresponding to the amount of the special color ink in the image layer E, and may make the image head eject the image ink from the image head in an amount corresponding to the amount of the special color ink in the image layer E.

For example, while the ejection amount of the image ink to the second image region E2 formed by the special color ink is 100% in the first printing mode, the ejection amount of the image ink changes in accordance with the gradation value o of orange and the gradation value g of green in the second image region E2 in the second printing mode. For example, in the printing operation in the second printing mode, the control device 50 decreases the ejection amount of the image ink to the second image region E2 as the gradation value o of orange and the gradation value g of green of the second image region E2 are larger. Here, the control device 50 may also reduce the ejection amount of the base ink to the first image region E1 corresponding to the second image region E2. In this way, as the amount of the special color ink that easily bleeds increases, the amount of the image ink, or the amounts of the image ink and the base ink decrease, and thus the bleeding of the image ink on the second base region D2 can be reduced.

In the printing apparatus 10 according to a third modification directed to the above embodiment, the control device 50 may make the ejection amounts of the base inks to the first base region D1 and the second base region D2, the ejection amounts of the image inks to the first image region E1 and the second image region E2, or the ejection amounts of the base inks to the first base region D1 and the second base region D2 and the ejection amounts of the image inks to the first image region E1 and the second image region E2 smaller in the second printing mode than in the first printing mode as the image inks forming the first image region E1 and the second image region E2 more easily bleed. Hereinafter, a case where the ejection amount of the base ink decreases as the image ink more easily bleeds will be described. Similarly to this case, the ejection amount of the image ink and the ejection amounts of both the base ink and the image ink can be reduced as the image ink more easily bleeds.

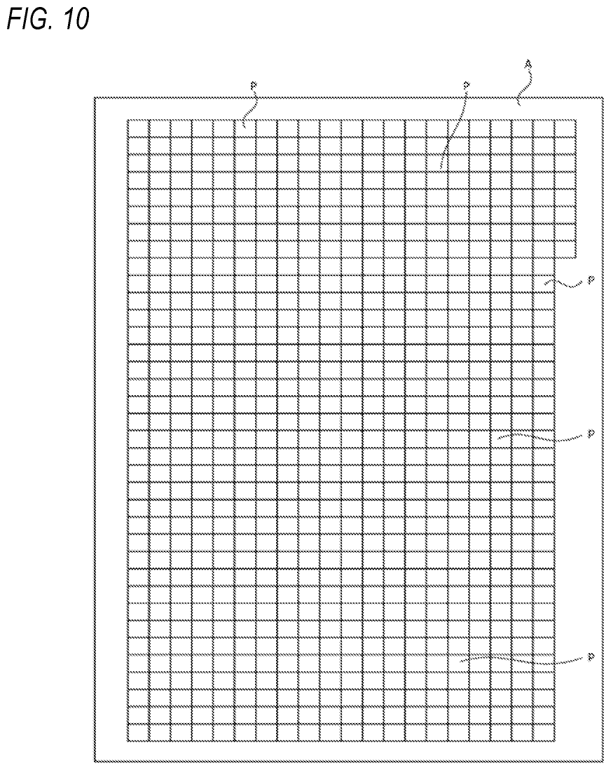

For example, as shown in FIG. 3, the printing apparatus 10 includes a color measurement device 58, and the color measurement device 58 is connected to the control device 50. Then, as shown in the example of FIG. 10, the printing apparatus 10 prints a plurality of color patches P having different colors in the first printing mode and a third printing mode. The third printing mode is a printing mode for reducing bleeding of an image ink as compared with the first printing mode. For example, in a printing operation in the third printing mode, bleeding of the image ink on the base layer D is reduced by forming the base layer D on the medium to be printed A with the base ink, drying the base layer D, and then forming the color patches P on the base layer D with the image ink. In the printing operation in the third printing mode, the bleeding of the image ink on the base layer D is reduced by printing the color patches each P having a size larger than that in the first printing mode.

Then, the printing apparatus 10 forms the base layer D on the medium to be printed A by using the base ink in each of the first printing mode and the third printing mode, forms (prints) the image layer E constituting the color patches P on the base layer D by using the image ink, and measures colors of the color patches P by the color measurement device 58. In the color measurement of the color patches P, for example, the control device 50 obtains an average color value of the color patches P by using the color measurement device 58 having an aperture of a large size or by measuring colors at a plurality of positions in the color patches P. Accordingly, the control device 50 calculates a color difference that is an absolute value of a difference between the average color value of the color patches P printed in the first printing mode and the average color value of the color patches P printed in the third printing mode. As the color difference is larger, the image ink more easily bleeds on the base layer D.

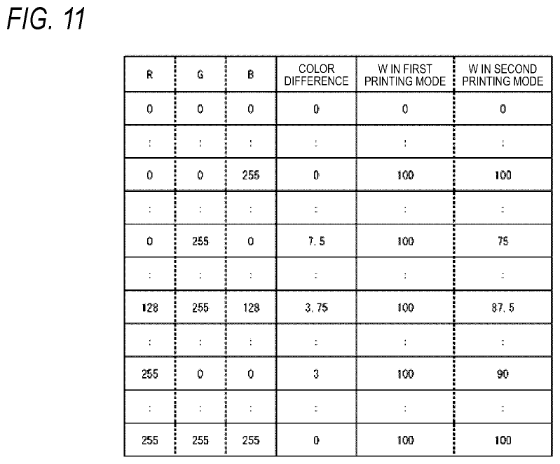

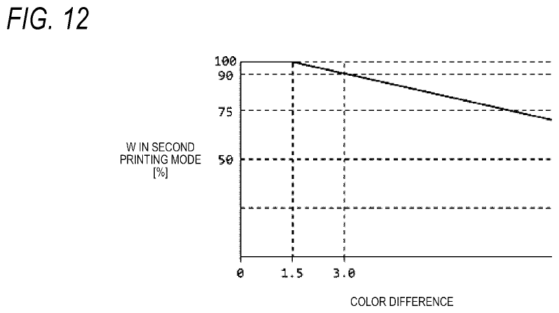

Therefore, in a third base LUT of FIG. 11, RGB, a color difference, W in the first printing mode, and W in the second printing mode are associated with one another. Here, RGB of the color patch P is associated with the color difference obtained for the color patch P. While W in the first printing mode is 100% regardless of the color difference, W in the second printing mode changes according to the color difference. W in the second printing mode is associated with the color difference as shown in FIG. 12. Here, when the color difference is equal to or greater than a predetermined value (for example, 1.5), as the color difference is larger, the image ink more easily bleeds, and thus W in the second printing mode is set to be smaller. When the color difference of the color patch P is less than the predetermined value, Win the second printing mode is 100%.

When print data is generated based on the image data in steps S3 and S5 of FIG. 5, the third base LUT and an image LUT are used. Then, the printing apparatus 10 executes the printing operation in the second printing mode based on the print data, so that the base ink is ejected onto the medium to be printed A to form the base layer D, and the image ink is ejected onto the base layer D to form the image layer E. In the base layer D, as a color difference of the image layer E is larger, an ejection amount of the base ink to the region corresponding to the region is smaller. Accordingly, it is possible to reduce the bleeding of the image ink on the base region in the region where the color difference of the image layer E is large and the image ink easily bleeds.

In the printing apparatus 10 according to fourth modification directed to the above embodiment and to the first to third modifications, a second printing mode includes a saturation priority mode and a brightness priority mode. When a printing operation is executed in the saturation priority mode, the control device 50 reduces an ejection amount of a base ink compared to that in the first printing mode. When a printing operation is executed in the brightness priority mode, the control device 50 reduces the ejection amount of the image ink compared to that in the first printing mode.

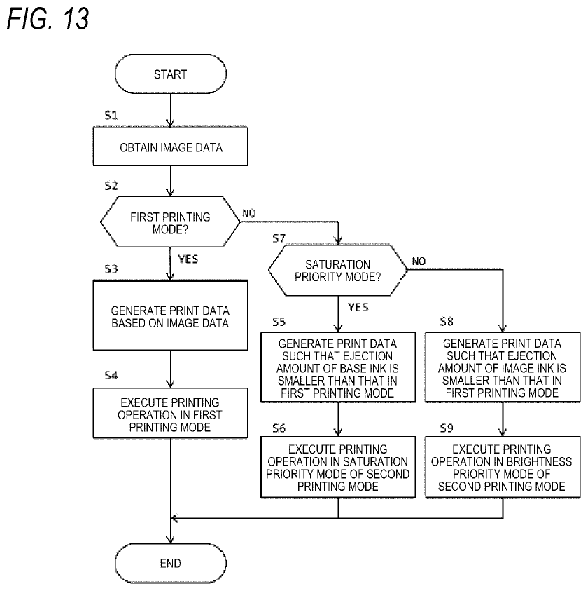

For example, the control method for the printing apparatus 10 is executed by the control device 50 according to an example of a flowchart shown in FIG. 13. In the flowchart of FIG. 13, processing of step S7 is executed between step S2 and step S5 in the flowchart of FIG. 5, and processing of step S8 and step S9 are executed after step S7. Other processing in the flowchart of FIG. 13 is similar to that in the flowchart of FIG. 5.

In step S2, if the printing mode is the second printing mode (step S2: NO), the control device 50 determines whether the second printing mode is the saturation priority mode (step S7). Here, for example, the control device 50 displays the saturation priority mode and the brightness priority mode of the first printing mode and the second printing mode on the display device 16 as options of the printing mode. When the user selects a printing mode using the input device 17, the selected printing mode is input to the control device 50.

If the second printing mode is the saturation priority mode (step S7: YES), the control device 50 generates print data such that an ejection amount of a base ink is smaller than that in the first printing mode (step S5). Then, the control device 50 executes the printing operation in the saturation priority mode of the second printing mode based on the print data (step S6).

In the printing operation in the saturation priority mode, the ejection amount of the base ink to the second base region D2 of the base layer D is smaller than that in the first printing mode. Therefore, the base layer D dries more readily, and the bleeding of the image ink ejected onto the base layer D can be reduced. Since the ejection amount of the image ink to the second image region E2 in the printing operation in saturation priority mode is larger than that in the brightness priority printing mode, and for example, equal to that in the first printing mode, it is possible to suppress a decrease in saturation of the second image region E2 due to a decrease in the image ink.

In step S7, if the second printing mode is the brightness priority mode (step S7: NO), the control device 50 generates print data such that the ejection amount of the image ink is smaller than that in the first printing mode (step S8). Then, the control device 50 executes the printing operation in the brightness priority mode of the second printing mode based on the print data (step S9).

In the printing operation in the brightness priority mode, the ejection amount of the image ink to the second image region E2 is smaller than that in the first printing mode. Therefore, the image ink is unlikely to spread, and the bleeding of the image ink ejected onto the base layer D can be reduced. Since the ejection amount of the base ink to the second base region D2 in the printing operation in the brightness priority mode is larger than that in the saturation priority printing mode, and for example, equal to that in the first printing mode, it is possible to suppress a decrease in brightness of the second image region E2 due to a decrease in the base ink.

### Modification 5

In the printing apparatus 10 according to fifth modification directed to the above embodiment and to the first to fourth modifications, the control device 50 determines whether printing conditions including the type of the medium to be printed A, the type of a pretreatment performed on the medium to be printed A before the ejection of the base ink, or the type of a method for fixing the base layer D to the medium to be printed A are predetermined conditions, and executes a printing operation in a second printing mode when the printing condition is the predetermined condition.

For example, in the determination of the printing mode in step S2 of FIGS. 5 and 13, the control device 50 determines whether the print conditions are the predetermined conditions. First, the control device 50 identifies the printing conditions. The print conditions may be input to the control device 50 from the external device F via the communication interface 52, or may be input to the control device 50 by the user operating the input device 17.

When the print conditions are input through the input device 17, the control device 50 displays the print condition on the display device 16. In response to this, when the user selects print conditions using the input device 17, the selected print conditions are input to the control device 50. Among the printing conditions, examples of the type of the medium to be printed A include a manufacturer and a model number of the medium to be printed A, examples of the type of the pretreatment include components of a pretreatment liquid and a manufacturer, and examples of the type of the fixing method include fixing using an oven, fixing using a heat press, and fixing using both the oven and the heat press. The print conditions are not limited to the type of the medium to be printed A, the type of the pretreatment, and the type of the fixing method. For example, the print conditions may be added by the user using the input device 17 or may be added by the manufacturer or the like via the communication interface 52.

In the pretreatment, the pretreatment liquid is applied to the medium to be printed A before the base ink is ejected onto the medium to be printed A. The pretreatment liquid is, for example, a liquid containing a polyvalent metal salt or an organic acid, and may further contain a resin. The pretreatment liquid may be applied by a coating device provided separately from the printing apparatus 10, or may be applied by the printing apparatus 10. The coating device or the printing apparatus 10 includes a nozzle that applies the pretreatment liquid, such as a spray nozzle. An application range of the pretreatment liquid includes a printing range of the image by the printing operation. Therefore, the ink used in the printing operation lands on the application range of the pretreatment liquid. The pretreatment liquid forms a film in gaps between fibers on the medium to be printed A. The pretreatment liquid can improve color development and adhesion of the printed image.

Processing of the fixing method of the base layer D may be performed, for example, after the base layer D and the image layer E are formed on the medium to be printed A by the printing operation. In this processing, for example, the base layer D and the medium to be printed A are heated by the oven to fix the base layer D to the medium to be printed A. Further, the base layer D may be fixed to the medium to be printed A by applying pressure to the base layer D and the medium to be printed A while heating the base layer D and the medium to be printed A by heat pressing.

Then, the control device 50 compares the input print conditions with the predetermined conditions. As the predetermined conditions, the types of the medium to be printed A, the pretreatment, and the fixing method, the types of inks such as special color inks that easily bleed, are stored in the memory device 51 in advance. In a case where the input print conditions are not defined as conditions in which the ink easily bleeds under the predetermined condition, since the print conditions are not the predetermined conditions, the control device 50 determines that the printing mode is the first printing mode (step S2: YES), generates print data based on the image data in step S3, and executes a printing operation in the first printing mode based on the print data in step S4.

On the other hand, in a case where the input print conditions are not determined as conditions in which the ink easily bleeds under the predetermined conditions, the control device 50 determines that the printing mode is the second printing mode (step S2: NO), generates print data based on the image data in step S5, and executes a printing operation in the second printing mode based on the print data in step S6. In this way, in the printing conditions in which the ink easily bleeds, it is possible to suppress the bleeding of the image ink on the base layer D by making the ejection amount of the base ink in the second printing mode smaller than that in the first printing mode.

In step S5, the control device 50 may generate print data such that the ejection amount of the image ink or the ejection amounts of both the base ink and the image ink instead of the ejection amount of the base ink are smaller than those in the first printing mode. Accordingly, by the printing operation in the second printing mode in step S6, the ejection amount of the image ink and the ejection amounts of both the base ink and the image ink are reduced, and the bleeding of the image ink on the base layer D can be suppressed.

In the printing apparatus 10 according to a sixth modification directed to the above embodiment and to the first to fourth modifications, the control device 50 determines whether an image to be printed on the medium to be printed A satisfies a predetermined condition, and executes the printing operation in a second printing mode when the image satisfies the predetermined condition.

For example, in the determination of the printing mode in step S2 of FIGS. 5 and 13, the control device 50 determines whether the image to be printed on the medium to be printed A satisfies the predetermined condition. Here, for example, the control device 50 identifies a print size of the image on the medium to be printed A based on image data. Then, the control device 50 determines whether the print size is less than a size predetermined in a predetermined condition. If the print size of the image is less than the predetermined size, it is assumed that a difference between an ejection timing of the base ink and an ejection timing of the image ink is less than a predetermined value and the image ink easily bleeds, and the control device 50 determines that the printed image satisfies the predetermined condition and the printing mode is the second printing mode (step S2: NO). Then, the control device 50 generates print data in step S5, and executes a printing operation in the second printing mode based on the print data in step S6. By making the ejection amount of the base ink in the printing operation in the second printing mode smaller than that in the first printing mode, bleeding of the image ink on the base layer D can be suppressed.

On the other hand, if the print size of the image is equal to or larger than the predetermined size, it is assumed that the image ink is unlikely to bleed, and the control device 50 determines that the printed image does not satisfy the predetermined condition and the printing mode is the first printing mode (step S2: NO). Then, the control device 50 generates print data in step S3, and executes a printing operation in the first printing mode based on the print data in step S4.

The predetermined condition is not limited to the print size of the image. For example, the predetermined condition may be a density of a special color in the image. In this case, the control device 50 identifies a hue of a pixel from RGB of the pixel of the image based on the image data, determines whether the pixel includes the special color based on the hue of the pixel, and identifies the pixel including the special color. Then, the control device 50 divides the image into a plurality of regions, and calculates the ratio of the number of pixels including the special color in the divided regions to the number of pixels in the divided regions as a special color density. The predetermined condition is that the image includes a divided region in which the special color density is equal to or higher than a predetermined density.

In a case where the image includes the divided region in which the special color density is equal to or higher than the predetermined density, it is assumed that the ratio of the special color ink is large in the print region corresponding to the divided region and the image ink easily bleeds, and the control device 50 determines that the image satisfies the predetermined condition and the printing mode is the second printing mode (step S2: NO). Then, the control device 50 generates print data based on the image data in step S5, and executes a printing operation in the second printing mode based on the print data in step S6. By making the ejection amount of the base ink in the second printing mode smaller than that in the first printing mode, it is possible to suppress bleeding of the image ink on the base layer D.

On the other hand, in a case where the image does not include the divided region where the special color density is equal to or more than the predetermined density, it is assumed that the image ink does not easily bleed, and the control device 50 determines that the printed image does not satisfy the predetermined condition and the printing mode is the first printing mode (step S2: YES). Then, the control device 50 generates print data based on the image data in step S3, and executes a printing operation in the first printing mode based on the print data in step S4.

Further, the predetermined condition may be, for example, the ease of bleeding of the ink in the image. In this case, for example, the control device 50 identifies a color difference of the color patches P as in third modification, identifies a plurality of levels indicating the ease of bleeding of the image ink according to the color difference, and stores a table in which the RGB of the color patches P is associated with a level of the ease of bleeding in the memory device 51. The ease of bleeding table may be stored in the memory device 51 in advance.

Then, the control device 50 identifies a level of the ease of bleeding from the RGB of the pixel based on the image data with reference to the ease of bleeding table. Then, the control device 50 divides the image into a plurality of regions and calculates an average value of the levels of the ease of bleeding of the pixels in the divided regions. The control device 50 determines whether the image includes a divided region in which the average value of the levels is equal to or greater than a predetermined value. When the image includes a divided region in which the average value of the levels is equal to or greater than the predetermined value, the control device 50 determines that the image satisfies the predetermined condition and the printing mode is the second printing mode (step S2: NO). Then, the control device 50 generates print data based on the image data in step S5, and executes a printing operation in the second printing mode based on the print data in step S6. By making the ejection amount of the base ink in the second printing mode smaller than that in the first printing mode, it is possible to suppress bleeding of the image ink on the base layer D.

On the other hand, in a case where the image does not include the divided region in which the average value of the levels is equal to or greater than the predetermined value, the control device 50 determines that the printed image does not satisfy the predetermined condition and the printing mode is the first printing mode (step S2: YES). Then, the control device 50 generates print data based on the image data in step S3, and executes a printing operation in the first printing mode based on the print data in step S4.

In step S5, print data may be generated such that the ejection amount of the image ink or the ejection amounts of both the base ink and the image ink instead of the ejection amount of the base ink are smaller than those in the first printing mode. Accordingly, by the printing operation in the second printing mode in step S6, the ejection amount of the image ink and the ejection amounts of both the base ink and the image ink are reduced, and the bleeding of the image ink on the base layer D can be suppressed.

From the above description, many improvements and other embodiments of the present disclosure are apparent to those skilled in the art. Accordingly, the above description should be interpreted only as an example, and is provided for the purpose of teaching those skilled in the art the best mode for carrying out the present disclosure. Details of the structure and/or the function can be substantially changed without departing from the spirit of the present disclosure.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A printing apparatus comprising:
a base head configured to eject a base ink;
an image head configured to eject an image ink including a special color ink; and
a control device,
wherein the control device is configured to execute printing operation in one of printing modes including a first printing mode and a second printing mode, the printing operation in which the base ink is ejected from the base head to form a base layer on a medium to be printed, and the image ink is ejected from the image head to form an image layer on the base layer, and
wherein when the printing operation is executed in the second printing mode, the control device reduces an ejection amount of the base ink, an ejection amount of the image ink, or the ejection amount of the base ink and the ejection amount of the image ink compared to those in the first printing mode.

2. The printing apparatus according to claim 1,
wherein the image ink includes a first image ink and a second image ink,
wherein the image head includes:
a first image head configured to eject the first image ink; and
a second image head located closer to the base head than the first image head and configured to eject the second image ink,
wherein the image layer includes:
a first image region formed by the first image ink without being formed by the second image ink; and
a second image region formed by the second image ink,
wherein the base layer includes:
a first base region corresponding to the first image region; and
a second base region corresponding to the second image region, and
wherein when the printing operation is executed in the second printing mode, the control device reduces an ejection amount of the base ink forming the second base region, an ejection amount of the second image ink forming the second image region, or the ejection amount of the base ink forming the second base region and the ejection amount of the second image ink forming the second image region compared to an ejection amount of a corresponding ink in the first printing mode.

3. The printing apparatus according to claim 1,
wherein the image ink includes a basic color ink including a cyan ink, a magenta ink, a yellow ink, and a black ink; and the special color ink different from the basic color ink,
wherein the image head includes a basic color head configured to eject the basic color ink and a special color head configured to eject the special color ink,
wherein the image layer has a third image region formed by the basic color ink without being formed by the special color ink, and a fourth image region formed by the special color ink,
wherein the base layer includes a third base region corresponding to the third image region and a fourth base region corresponding to the fourth image region, and
wherein when the printing operation is executed in the second printing mode, the control device reduces an ejection amount of the base ink forming the fourth base region, an ejection amount of the special color ink forming the fourth image region, or the ejection amount of the base ink forming the fourth base region and the ejection amount of the special color ink forming the fourth image region compared to an ejection amount of a corresponding ink in the first printing mode.

4. The printing apparatus according to claim 1,
wherein when the printing operation is executed in the second printing mode, the control device controls:
the base head to eject the base ink in an amount corresponding to a hue of an image which is a target of the printing operation;
the image head to eject the image ink in an amount corresponding to the hue of the image; or
the base head to eject the base ink in the amount corresponding to a hue of an image and the image head to eject the image ink in the amount corresponding to the hue of the image.

5. The printing apparatus according to claim 1,
wherein the control device identifies an amount of the special color ink included in the image ink forming the image layer,
wherein when the printing operation is executed in the second printing mode, the control device controls:
the base head to eject the base ink in an amount corresponding to the amount of the special color ink in the image layer;
the image head to eject the image ink in an amount corresponding to the amount of the special color ink in the image layer, or
the base head to eject the base ink in the amount corresponding to the amount of the special color ink in the image layer and the image head to eject the image ink in the amount corresponding to the amount of the special color ink in the image layer.

6. The printing apparatus according to claim 1,
wherein the second printing mode includes a saturation priority mode and a brightness priority mode,
wherein the control device reduces, in the saturation priority mode, an ejection amount of the base ink compared to that in the first printing mode, and
wherein the control device reduces, in the brightness priority mode, an ejection amount of the image ink compared to that in the first printing mode.

7. The printing apparatus according to claim 1,
wherein the control device is further configured to:
determine whether a printing condition including a type of the medium to be printed, a type of a pretreatment performed on the medium to be printed before the ejection of the base ink, or a type of a method for fixing the base layer to the medium to be printed is a predetermined condition, and
execute the printing operation in the second printing mode in response to determining that the printing condition is the predetermined condition.

8. The printing apparatus according to claim 1,
wherein the control device is further configured to:
determine whether an image to be printed on the medium to be printed satisfies a predetermined condition, and
execute the printing operation in the second printing mode in response to determining that the image satisfies the predetermined condition.

9. A control method for a printing apparatus,
wherein the printing apparatus includes: a base head configured to eject a base ink, and an image head configured to eject an image ink including a special color ink,
wherein the control method comprises:
executing a printing operation in one of printing modes including a first printing mode and a second printing mode, the printing operation in which the base ink is ejected from the base head to form a base layer on a medium to be printed, and the image ink is ejected from the image head to form an image layer on the base layer; and
reducing, in the second printing mode, an ejection amount of the base ink, an ejection amount of the image ink, or the ejection amount of the base ink and the ejection amount of the image ink compared to an ejection amount of a corresponding ink in the first printing mode.

10. Anon-transitory computer-readable storage medium storing a program for a control device of a printing apparatus,
wherein the printing apparatus includes a base head configured to eject a base ink, and an image head configured to eject an image ink including a special color ink,
wherein the program causes the control device to execute a process comprising:
executing a printing operation in one of printing modes including a first printing mode and a second printing mode, the printing operation in which the base ink is ejected from the base head to form a base layer on a medium to be printed, and the image ink is ejected from the image head to form an image layer on the base layer; and
reducing, in the second printing mode, an ejection amount of the base ink, an ejection amount of the image ink, or the ejection amount of the base ink and the ejection amount of the image ink compared to an ejection amount of a corresponding ink in the first printing mode.
